(19) United States
(12) Patent Application Publication
(10) Pub. No.: US 2026/0188082 A1
(43) Pub. Date: Jul. 2, 2026

(54) POCKET FEEDING TRANSPORT SYSTEM AND METHOD

(71) Applicant: Cardtronics USA, Inc., Atlanta, GA (US)

(72) Inventors: Callum Jacklin, Dundee (GB); Scott Low Colston, Dundee (GB); Matthew Bowen, Perth (GB); Zelin Liu, Monifieth (GB); Jamie Kenneth Stewart, Dundee (GB)

(21) Appl. No.: 19/006,331

(22) Filed: Dec. 31, 2024

(51) Int. Cl. G07F 19/00; G07D 11/165; G07D 11/17

(52) U.S. Cl. CPC G07F 19/202; G07D 11/165; G07D 11/17; G07D 2211/00

(57) ABSTRACT

A device may include a pocket to receive bank notes. A device may include a stage plate, wherein the stage plate is moveable up and down within the pocket in a range of motion. A device may include a number of rollers configured to engage one or more bank notes on the stage plate when the stage plate is at a picking location within the range of motion, the number of rollers including, two or more pick rollers along a first common axis of rotation, wherein the two or more pick rollers define a region between outermost pick rollers; and a number of transport rollers along a second common axis of rotation, the second common axis of rotation spaced apart from the first common axis of rotation, wherein the number of transport rollers includes a group of two or more transport rollers located laterally between the two or more pick rollers in the region and arranged symmetrically with respect to the two or more pick rollers.

### TECHNICAL FIELD

Embodiments described herein generally relate to automatic teller machines and associated methods. Specific embodiments described herein relate to recycling automatic teller machines and configurations related to a slot for receiving bank notes.

### BACKGROUND

Automated Teller Machines (ATMs) have become an integral component of modern banking, enabling customers to perform a variety of transactions, including cash withdrawals, deposits, and balance inquiries. Despite their widespread use, traditional ATMs are typically limited in their ability to manage cash flow efficiently, particularly with respect to the handling, sorting, and redistribution of deposited currency. This inefficiency often leads to increased operational costs for financial institutions, including the need for frequent cash replenishment and manual cash handling by service personnel.

In response to these challenges, Automated Teller Recycler (ATR) machines have emerged as an innovative solution. ATRs integrate cash recycling capabilities into the traditional ATM framework. Unlike standard ATMs, ATRs are equipped with advanced mechanisms for verifying, sorting, and securely storing deposited banknotes. These stored banknotes can subsequently be reused for withdrawal transactions, effectively creating a closed-loop cash management system. This functionality reduces the frequency of cash replenishment, optimizes cash availability, and lowers the overall cost of operation.

Despite their advantages, the implementation of ATRs poses several challenges. For instance, ensuring the accurate authentication of deposited currency is critical to prevent the circulation of counterfeit banknotes. One technical challenge includes reliable mechanisms to pick bank notes from a stack, and to transport picked bank notes within an ATR. Devices and methods are described in the present disclosure that address these concerns, and other technical challenges.

### BRIEF DESCRIPTION OF THE DRAWINGS

FIG. 1 shows a schematic of an automatic teller machine in accordance with some example embodiments.

FIG. 2A shows a block diagram of a pocket of an automatic teller machine in accordance with some example embodiments.

FIG. 2B shows another block diagram of a pocket of an automatic teller machine in accordance with some example embodiments.

FIG. 3 shows a block diagram including rollers within a pocket of an automatic teller machine in accordance with some example embodiments.

FIG. 4A shows a block diagram including rollers within a pocket of an automatic teller machine in accordance with some example embodiments.

FIG. 4B shows a side view of rollers of an automatic teller machine in accordance with some example embodiments.

FIG. 5 shows a top view of rollers of an automatic teller machine in accordance with some example embodiments.

FIG. 6 shows an isometric view of rollers of an automatic teller machine in accordance with some example embodiments.

FIG. 7 shows a flow diagram of a method in accordance with some example embodiments.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

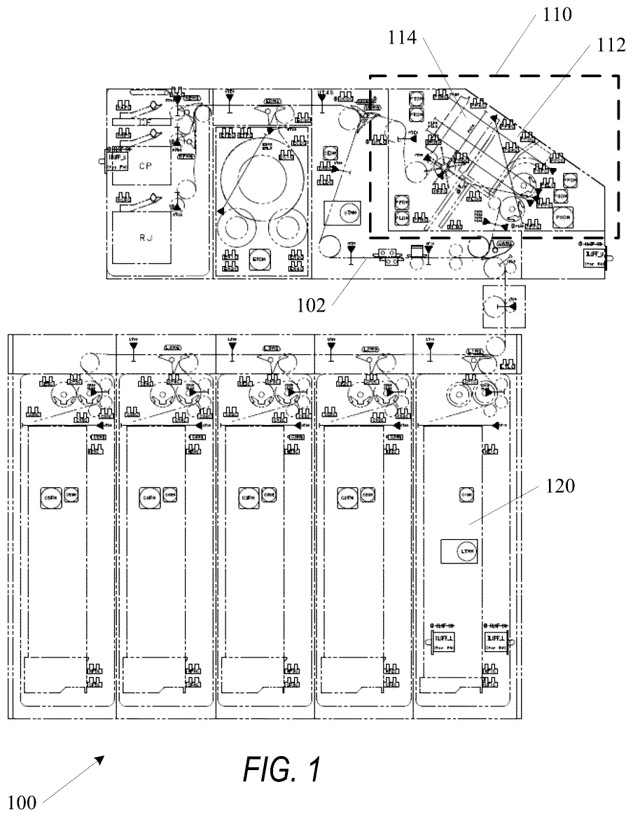

FIG. 1 shows an automatic teller machine 100 according to one example. The automatic teller machine 100 includes a pocket assembly 110. In the example of FIG. 1, the pocket assembly 110 is divided into a bottom compartment 112 and a top compartment 114. The pocket assembly 110 serves as the primary area for receiving and processing bank notes within the automatic teller machine 100. The bottom compartment 112 and the top compartment 114 are designed to facilitate the movement and storage of bank notes during various stages of a transaction process.

One or more note storage compartments 120 are shown. A belt 102 or other transport system is coupled between various components in the pocket assembly 110 and the note storage compartments 120. The note storage compartments 120 are connected to the pocket assembly 110 and provide a secure location for storing bank notes after they have been processed. The note storage compartment 120 ensures that bank notes are kept in an organized manner, ready for future transactions or for collection by authorized personnel. The connection between the pocket assembly 110 and the note storage compartment 120 allows for efficient transfer and storage of bank notes within the automatic teller machine 100.

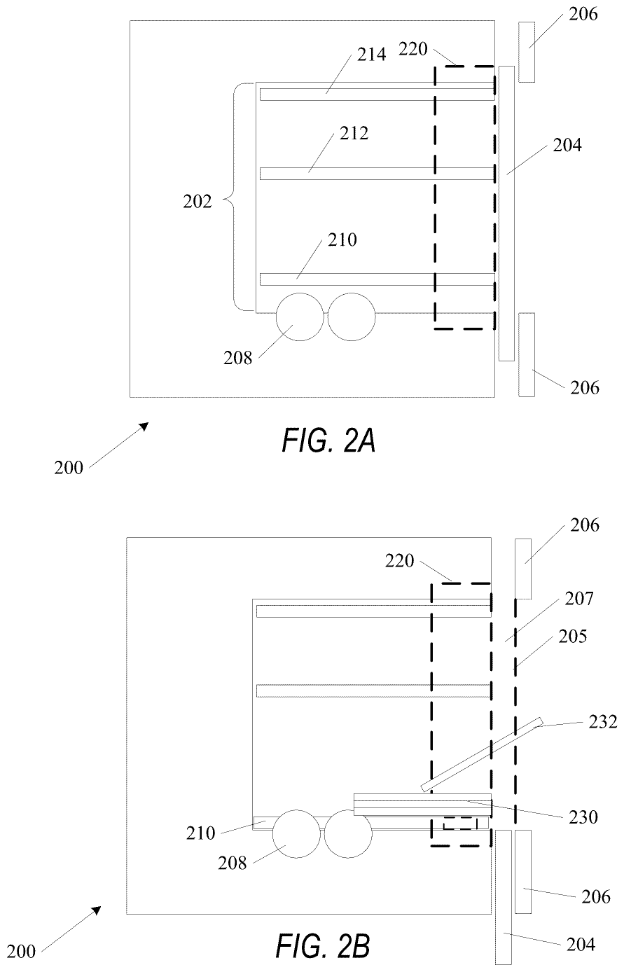

FIGS. 2A and 2B show a pocket assembly 200 similar to the pocket assembly 110 from FIG. 1. In FIG. 2A, a shutter 204 is shown in a closed position, covering a pocket 202. The pocket assembly 200 includes a pocket 202, which serves as the primary area for receiving bank notes. The fascia 206 is located on an exterior surface of the automatic teller machine, surrounding the pocket 202 and providing an interface for users. In the examples of FIGS. 2A and 2B, within the pocket 202, a stage plate 210 is shown, which is moveable up and down to facilitate the handling of bank notes.

Above the stage plate 210, a pusher plate 212 is located, which is also moveable up and down within the pocket 202 to press bank notes against the stage plate 210. A top plate 214 is positioned above the pusher plate 212. In one example, the top plate 214 is also moveable up and down within the pocket 202. On the side of the pocket 202, a side guide 220 is present, which aids in aligning bank notes within the pocket 202.

In the position shown in FIG. 2A, the stage plate 210 and a pusher plate 212 define a bottom compartment, similar to the bottom compartment 112 from FIG. 1. In operation, a stack of bank notes 230 is inserted onto the stage plate 210 and the stage plate is lowered as shown in FIG. 2B. One or more rollers 208 protrude through the stage plate 210 in FIG. 2B and are used to transport individual notes 232 within the automatic teller machine. In one example, the pusher plate 212 is also lowered to apply pressure to the stack of bank notes 230 while the rollers 208 engage the stack, although not shown in FIG. 2B.

A slot 207 is included to guide the shutter 204 between an extended position (shown in FIG. 2A) and a retracted position (shown in FIG. 2B). An edge of the slot 207 is shown by dashed line 205, and the slot 207 is located between the pocket 202 and the fascia 206 of the automatic teller machine.

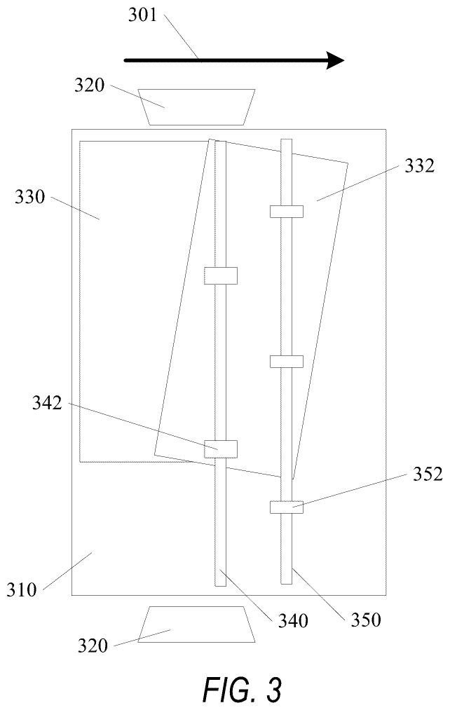

FIG. 3 shows a block diagram of the stage plate 310 as viewed from above. A bank note 332 is shown being picked from a stack of bank notes 330 on the stage plate 310 along direction 301. The stack of bank notes 330 are aligned against a side guide 320 within a pocket, similar to pocket 202 from FIGS. 2A and 2B.

FIG. 3 further shows a number of rollers configured to engage bank notes from the stack of bank notes 330 on the stage plate 310 when the stage plate is at a picking location within a range of motion in the pocket. The number of rollers includes a number of pick rollers 342 along a first common axis 340. The number of rollers also includes a number of transport rollers 352 along a second common axis 350. In operation, the pick rollers 342 pick one bank note 332 from a bottom of the stack of bank notes 330, and move the bank note 332 into the transport rollers 352. The transport rollers, then move the bank note 332 elsewhere in the automated teller machine, for example into a storage compartment, or into a top compartment, or elsewhere based on a property of the bank note 332 that is detected.

The pocket shown in FIG. 3 is configured to accommodate a number of different sized of bank notes. When smaller bank notes are loaded on the stage plate 310, they are aligned against the side guide 320 as shown. In one example, the bank notes 330, 332 have a long edge that is less than 140 mm. At this length, the bank notes 330, 332 do not contact one of the outside transport roller 352. In this configuration, there is an asymmetry present between the transport rollers 352 and the pick rollers 342. As such, the bank note 332 may begin to skew as shown in FIG. 3. The skewing is caused by the transport rollers 352 being offset from the pick rollers 342, at least for the size of bank note 332 shown in FIG. 3. The skewing shown is undesirable, and may cause issues such as jamming of the bank note 332.

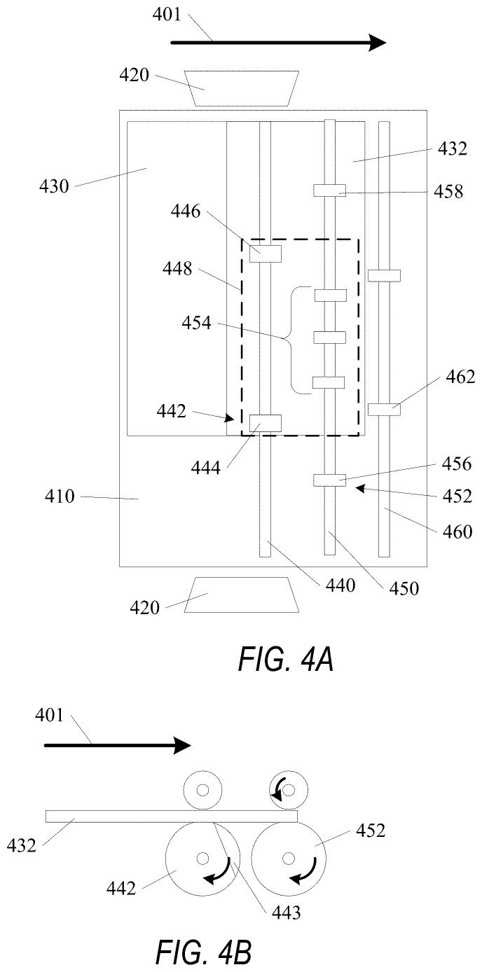

FIGS. 4A and 4B show a configuration of rollers that addresses the concern of skewing. FIG. 4A shows a block diagram of the stage plate 410 as viewed from above. A bank note 432 is shown being picked from a stack of bank notes 430 on the stage plate 410 along direction 401. The stack of bank notes 430 are aligned against a side guide 420 within a pocket, similar to pocket 202 from FIGS. 2A and 2B.

FIG. 4A further shows a number of rollers configured to engage bank notes from the stack of bank notes 430 on the stage plate 410 when the stage plate is at a picking location within a range of motion in the pocket. The number of rollers includes two or more pick rollers 442 along a first common axis of rotation 440. The two or more pick rollers 442 include a first outside pick roller 444 and a second outside pick roller 446. The two or more pick rollers 442 define a region 448 between outermost pick rollers 444 and 446.

FIG. 4A further shows a number of transport rollers 452 along a second common axis of rotation 450. The second common axis of rotation is spaced apart from the first common axis of rotation 440. The number of transport rollers 452 includes a group 454 of two or more transport rollers 452 located laterally between the two or more pick rollers 442 in the region 448 and arranged symmetrically with respect to the two or more pick rollers 442. A first outside transport roller 456 and a second outside transport roller 458 are shown spaced apart laterally from the group 454.

FIG. 4A further shows a second number of transport rollers 462 along a third common axis of rotation 460. The third common axis of rotation 460 is spaced apart from the second common axis of rotation 450.

FIG. 4B shows a side view of selected rollers from FIG. 4A. FIG. 4B shows a pick roller 442 advancing a bank note 432 into a transport roller 452. In FIG. 4B, the pick roller 442 includes an outer surface that is only partially coated with rubber, or another tacky material. In FIG. 4B, rubber portion 443 covers a portion of the pick roller 442.

In operation, the pick rollers 442 pick one bank note 432 from a bottom of a stack of bank notes 430, and move the bank note 432 into the transport rollers 452. The transport rollers, then move the bank note 432 elsewhere in the automated teller machine, for example into a storage compartment, or into a top compartment, or elsewhere based on a property of the bank note 432 that is detected. The rubber portion 443 serves to only advance the bank note 432 a desired distance, where the transport rollers 452 then pick up the bank note 432.

In FIG. 4A, because the number of transport rollers 452 includes a group 454 of two or more transport rollers 452 located laterally between the two or more pick rollers 442 in the region 448, a pinch force is increased, and is more consistently applied to the bank note 432 within the region 448. Because the group 454 of two or more transport rollers 452 is arranged symmetrically with respect to the two or more pick rollers 442, any drag force from the two or more pick rollers 442 is equally offset by a pulling force in the two or more transport rollers 452. Properties of the configuration in FIG. 4A, such as the increase in pinch force locations within the region 448 and the symmetric arrangement within the region 448 reduces or eliminates undesirable skew of bank notes, such as the skew illustrated in FIG. 3.

In one example, pinch forces are varied across different transport rollers 452. In one example, a pinch force applied to more central transport rollers, such as group 454 is higher than a pinch force applied to outside transport rollers, such as transport rollers 456, 458. In one example, varying pinch forces are applied to different transport rollers, between 8.5 Newtons (N) and 2N. In one example, more than 8N is applied to central transport rollers in the group 454, and a pinch force of 2N or less is applied to outside transport rollers 456, 458. Differences in pinch force further control or eliminate unwanted skewing of bank notes as illustrated in FIG. 3.

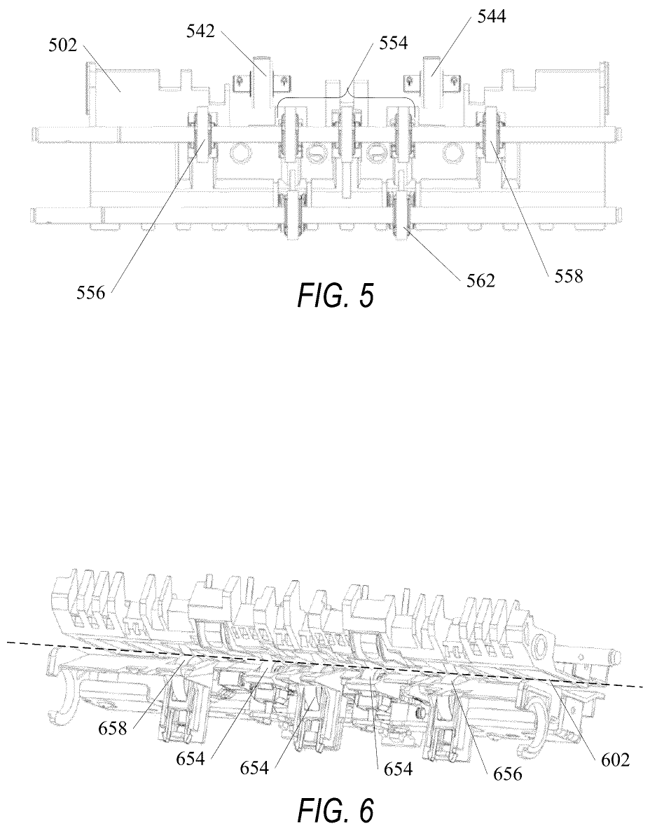

FIG. 5 shows another example of roller arrangements according to the present disclosure. Rollers are shown in context within a frame 502. A first pick roller 542 and a second pick roller 544 are shown. A group of transport rollers 554 and outside transport rollers 556, 558 are shown. In FIG. 5, a second number of transport rollers 562 are also shown.

FIG. 6 shows a roller arrangement in context with additional structure in an automated teller machine. FIG. 6 shows a group of transport rollers 654 and outside transport rollers 656 and 658. The transport rollers of FIG. 6 meet corresponding opposing rollers along an interface 602. In operation, pressure between the transport rollers and the opposing rollers provides a pinch force as discussed above.

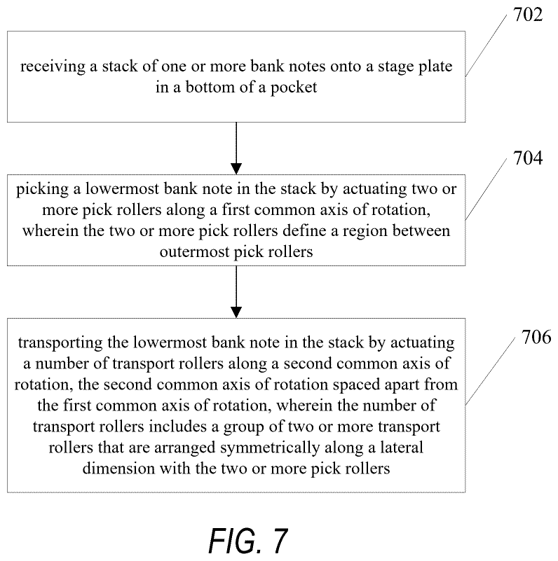

FIG. 7 shows a flow diagram of a method of operating an automated teller machine according to one example. In operation 702, a stack of one or more bank notes are received onto a stage plate in a bottom of a pocket. In operation 704, a lowermost bank note in the stack is picked by actuating two or more pick rollers along a first common axis of rotation, wherein the two or more pick rollers define a region between outermost pick rollers. In operation 706, the lowermost bank note in the stack is transported by actuating a number of transport rollers along a second common axis of rotation, the second common axis of rotation spaced apart from the first common axis of rotation, wherein the number of transport rollers includes a group of two or more transport rollers that are arranged symmetrically along a lateral dimension with the two or more pick rollers.

To better illustrate the method and apparatuses disclosed herein, a non-limiting list of embodiments is provided here:
Example 1. An automatic teller machine, comprising: a pocket to receive bank notes; a stage plate, wherein the stage plate is moveable up and down within the pocket in a range of motion; a number of rollers configured to engage one or more bank notes on the stage plate when the stage plate is at a picking location within the range of motion, the number of rollers including; two or more pick rollers along a first common axis of rotation, wherein the two or more pick rollers define a region between outermost pick rollers; and a number of transport rollers along a second common axis of rotation, the second common axis of rotation spaced apart from the first common axis of rotation, wherein the number of transport rollers includes a group of two or more transport rollers located laterally between the two or more pick rollers in the region and arranged symmetrically with respect to the two or more pick rollers.
Example 2. The automatic teller machine of example 1, wherein the group of two or more transport rollers includes a larger number of rollers than the two or more pick rollers in the region.
Example 3. The automatic teller machine of example 1, wherein the group of two or more transport rollers includes three rollers.
Example 4. The automatic teller machine of example 1, wherein the region includes two pick rollers and three transport rollers.
Example 5. The automatic teller machine of example 1, wherein the number of transport rollers further includes one or more transport rollers laterally spaced outside the region.
Example 6. The automatic teller machine of example 1, wherein the two or more pick rollers include an outer surface that is only partially coated with rubber.
Example 7. The automatic teller machine of example 1, wherein the two or more pick rollers are arranged such that all pick rollers contact a bank note having a long dimension smaller than 140 mm when the bank note is aligned against a sidewall of the pocket.
Example 8. The automatic teller machine of example 1, further including a second number of transport rollers along a third common axis of rotation, the third common axis of rotation spaced apart from the second common axis of rotation.
Example 9. A method of receiving bank notes in an automatic teller machine, comprising: receiving a stack of one or more bank notes onto a stage plate in a bottom of a pocket; picking a lowermost bank note in the stack by actuating two or more pick rollers along a first common axis of rotation, wherein the two or more pick rollers define a region between outermost pick rollers; and transporting the lowermost bank note in the stack by actuating a number of transport rollers along a second common axis of rotation, the second common axis of rotation spaced apart from the first common axis of rotation, wherein the number of transport rollers includes a group of two or more transport rollers that are arranged symmetrically along a lateral dimension with the two or more pick rollers.
Example 10. The method of example 9, wherein receiving the stack of one or more bank notes includes receiving a stack of bank notes that occupy only a fraction of the pocket, and aligning the stack of bank notes against a sidewall of the pocket.
Example 11. The method of example 9, wherein actuating two or more pick rollers includes actuating pick rollers with an outer surface that is only partially coated with rubber.
Example 12. The method of example 9, wherein actuating a number of transport rollers includes actuating a larger number of transport rollers than the two or more pick rollers in the region.
Example 13. The method of example 12, wherein actuating the larger number of transport rollers than the two or more pick rollers in the region includes actuating three transport rollers located laterally between two pick rollers.
Example 14. The method of example 13, wherein actuating the number of transport rollers includes applying a pinch force to the number of transport rollers, wherein a pinch force applied to more central transport rollers is higher than a pinch force applied to outside transport rollers.
Example 15. The method of example 14, wherein applying the pinch force includes applying varying pinch forces to different transport rollers, between 8.5N and 2N.
Example 16. The method of example 14, wherein actuating the number of transport rollers includes actuating 5 transport rollers, and wherein applying the pinch force includes applying more than 8N to three central transport rollers, and wherein applying the pinch force includes applying 2N or less to outside transport rollers.
Example 17. The method of example 9, wherein receiving the stack of one or more bank notes onto the stage plate includes receiving a stack of bank notes with a long dimension less than 140 mm.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. An automatic teller machine, comprising:
a pocket to receive bank notes;
a stage plate, wherein the stage plate is moveable up and down within the pocket in a range of motion;
a number of rollers configured to engage one or more bank notes on the stage plate when the stage plate is at a picking location within the range of motion, the number of rollers including;
two or more pick rollers along a first common axis of rotation, wherein the two or more pick rollers define a region between outermost pick rollers; and
a number of transport rollers along a second common axis of rotation, the second common axis of rotation spaced apart from the first common axis of rotation, wherein the number of transport rollers includes a group of two or more transport rollers located laterally between the two or more pick rollers in the region and arranged symmetrically with respect to the two or more pick rollers.

2. The automatic teller machine of claim 1, wherein the group of two or more transport rollers includes a larger number of rollers than the two or more pick rollers in the region.

3. The automatic teller machine of claim 1, wherein the group of two or more transport rollers includes three rollers.

4. The automatic teller machine of claim 1, wherein the region includes two pick rollers and three transport rollers.

5. The automatic teller machine of claim 1, wherein the number of transport rollers further includes one or more transport rollers laterally spaced outside the region.

6. The automatic teller machine of claim 1, wherein the two or more pick rollers include an outer surface that is only partially coated with rubber.

7. The automatic teller machine of claim 1, wherein the two or more pick rollers are arranged such that all pick rollers contact a bank note having a long dimension smaller than 140 mm when the bank note is aligned against a sidewall of the pocket.

8. The automatic teller machine of claim 1, further including a second number of transport rollers along a third common axis of rotation, the third common axis of rotation spaced apart from the second common axis of rotation.

9. A method of receiving bank notes in an automatic teller machine, comprising:
receiving a stack of one or more bank notes onto a stage plate in a bottom of a pocket;
picking a lowermost bank note in the stack by actuating two or more pick rollers along a first common axis of rotation, wherein the two or more pick rollers define a region between outermost pick rollers; and
transporting the lowermost bank note in the stack by actuating a number of transport rollers along a second common axis of rotation, the second common axis of rotation spaced apart from the first common axis of rotation, wherein the number of transport rollers includes a group of two or more transport rollers that are arranged symmetrically along a lateral dimension with the two or more pick rollers.

10. The method of claim 9, wherein receiving the stack of one or more bank notes includes receiving a stack of bank notes that occupy only a fraction of the pocket, and aligning the stack of bank notes against a sidewall of the pocket.

11. The method of claim 9, wherein actuating two or more pick rollers includes actuating pick rollers with an outer surface that is only partially coated with rubber.

12. The method of claim 9, wherein actuating a number of transport rollers includes actuating a larger number of transport rollers than the two or more pick rollers in the region.

13. The method of claim 12, wherein actuating the larger number of transport rollers than the two or more pick rollers in the region includes actuating three transport rollers located laterally between two pick rollers.

14. The method of claim 13, wherein actuating the number of transport rollers includes applying a pinch force to the number of transport rollers, wherein a pinch force applied to more central transport rollers is higher than a pinch force applied to outside transport rollers.

15. The method of claim 14, wherein applying the pinch force includes applying varying pinch forces to different transport rollers, between 8.5N and 2N.

16. The method of claim 14, wherein actuating the number of transport rollers includes actuating 5 transport rollers, and wherein applying the pinch force includes applying more than 8N to three central transport rollers, and wherein applying the pinch force includes applying 2N or less to outside transport rollers.

17. The method of claim 9, wherein receiving the stack of one or more bank notes onto the stage plate includes receiving a stack of bank notes with a long dimension less than 140 mm.
